(19) United States
(12) Patent Application Publication
(10) Pub. No.: US 2026/0180297 A1
(43) Pub. Date: Jun. 25, 2026

(54) MECHANICAL POWER DISTRIBUTION BOX FOR A FREEZE DRYER CONTROL SYSTEM AND A METHOD OF USING THE SAME

(71) Applicant: Patrick Scott Sittnick, Hendersonville, TN (US)

(72) Inventor: Patrick Scott Sittnick, Hendersonville, TN (US)

(21) Appl. No.: 18/999,839

(22) Filed: Dec. 23, 2024

(51) Int. Cl. H02G 3/16; A23B 2/92

(52) U.S. Cl. CPC H02G 3/16; A23B 2/92

(57) ABSTRACT

A power distribution system enabling a plurality of freeze dryers by way of a single vacuum pump. The system includes an enclosure providing a box power receptacle, a single pump power receptacle, and a plurality of pump port inlets, wherein relay electrically coupled between the single pump power receptacle and the plurality of pump port inlets, wherein the relay is configured to selectively interrupt power to the plurality of pump port inlets. The single vacuum pump is electrically coupled to the single pump power receptacle, and the plurality of freeze dryers is electrically coupled to the plurality of pump port inlets, respectively.

### BACKGROUND OF THE SUBJECT DISCLOSURE

The present subject disclosure relates to freeze dryer systems and, more particularly, to a mechanical power distribution box for a freeze dryer control system.

Freeze drying, also known as lyophilization or cryodesiccation, is a low temperature dehydration process that involves freezing the product and lowering pressure, thereby removing the ice by sublimation. This contrasts with dehydration by most conventional methods that evaporate water using heat. Freeze drying is viewed as the optimal method of choice for dehydration of food because of the preservation of quality, meaning characteristics of the food product such as aroma, rehydration, and bioactivity, are noticeably higher compared to foods dried using other techniques.

Freeze drying, however, costs about five times as much as conventional drying because of the amount of electrical power needed to operate the key components, wherein the most energy-intensive step is sublimation.

Generally speaking, a freeze-drying system includes the following systemic components: a chamber for holding the product while a hydraulic or electric motor is in place to ensure the door is vacuum-tight when closed; a process condenser of refrigerated coils or plates that can be external or internal to the chamber for trapping water; an external heat exchanger that circulates fluid around the system with a pump; a refrigeration system for cooling the process condenser and supplying energy necessary for the product to freeze; a vacuum system having one or more rotary vacuum pumps; and a control system that sets up controlled values for temperature, pressure, and time that are dependent on the product and/or the process, whereby the freeze dryer can run for a few hours or days depending on the product.

Because of the intensive electrical power performance needed to run a freeze dryer wires and control systems can overheat, especially when running multiple freeze dryers. Additionally, freeze dryers require costly electrical installation, especially for enthusiasts operating freeze dryers in their home, where current solutions require each freeze dryer to have their own vacuum pump. Unfortunately, there is no system currently available to split the amperage load of running multiple freeze dryers.

As can be seen, there is a need for a mechanical power distribution box for a freeze dryer motor control system, whereby the mechanical power distribution box enables splitting the amperage in half, between the freeze dryer and the external vacuum pump, thereby allowing a user of multiple freeze dryers to share a single pump for all of the multiple freeze dryers, while cooling all circuits involved, by way of a multi-channel variation has multiple trigger inputs for multiple freeze dryers.

### SUMMARY OF THE SUBJECT DISCLOSURE

A mechanical power distribution box for a freeze dryer system that enables splitting the amperage in half, between the freeze dryer and the external vacuum pump, thereby cooling all circuits involved.

The mechanical power distribution box of the subject disclosure enables multi-channel variations having multiple trigger inputs for multiple freeze dryers.

The mechanical power distribution box of the subject disclosure prevents wires and control systems from overheating, allows home users the ability to bypass a costly electrical installation, and enables multi-channel variations for multiple freeze dryers to share one vacuum pump.

In one aspect of the subject disclosure, a mechanical power distribution system enabling a plurality of freeze dryers by way of a single vacuum pump, the system provides an enclosure providing a box power receptacle, a single pump power receptacle, and a plurality of pump port inlets; and a relay electrically coupled between the single pump power receptacle and the plurality of pump port inlets, wherein the relay is configured to selectively interrupt power to the plurality of pump port inlets.

In another aspect of the subject disclosure, the power distribution system further provides the single vacuum pump electrically coupled to the single pump power receptacle, and the plurality of freeze dryers electrically coupled to the plurality of pump port inlets, respectively.

These and other features, aspects and advantages of the present subject disclosure will become better understood with reference to the following drawings, description and claims.

### BRIEF DESCRIPTION OF THE DRAWINGS

FIG. 1 is a front perspective view of an exemplary embodiment of the subject disclosure embodying a mechanical power distribution box invention.

FIG. 2 is a front perspective view of an exemplary embodiment of the subject disclosure.

FIG. 3 is a schematic diagram for a three-channel embodiment of the subject disclosure.

FIG. 4 is a wiring diagram for the three-channel embodiment of the subject disclosure.

FIG. 5 is a schematic diagram for a two-channel embodiment of the subject disclosure.

FIG. 6 is a wiring diagram for the two-channel embodiment of the subject disclosure.

FIG. 7 is a schematic diagram for a one-channel embodiment of the subject disclosure.

FIG. 8 is a wiring diagram for the one-channel embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

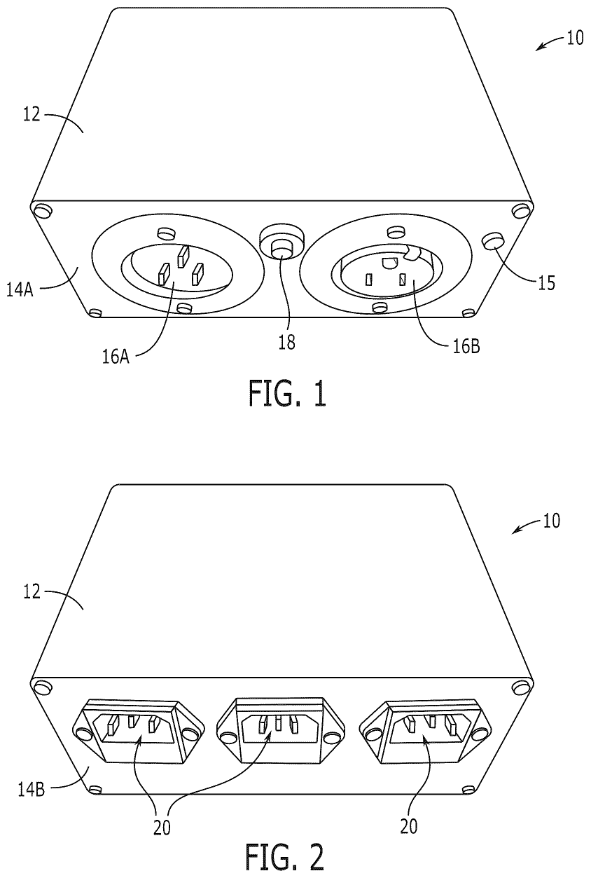

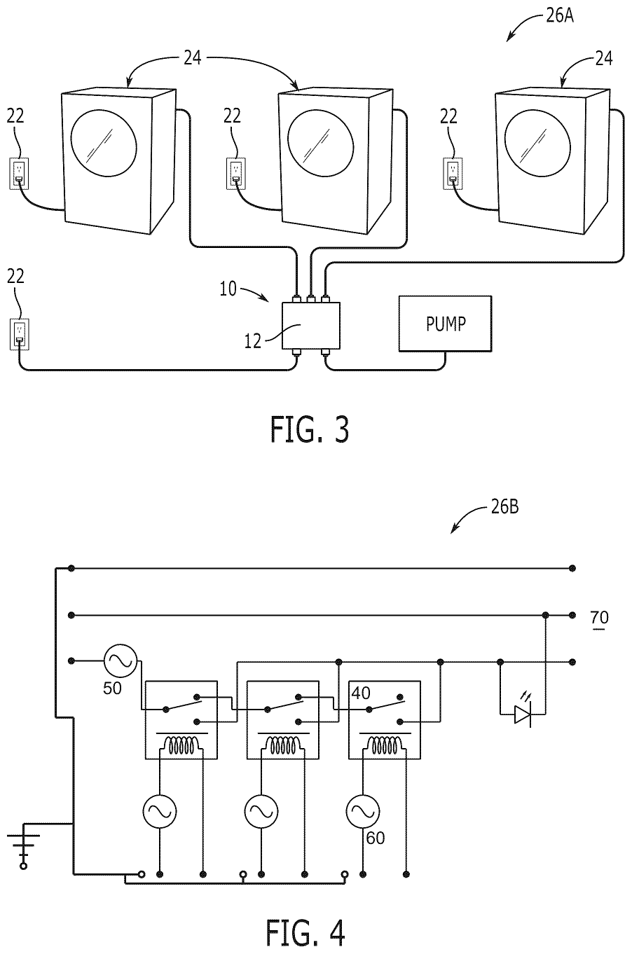

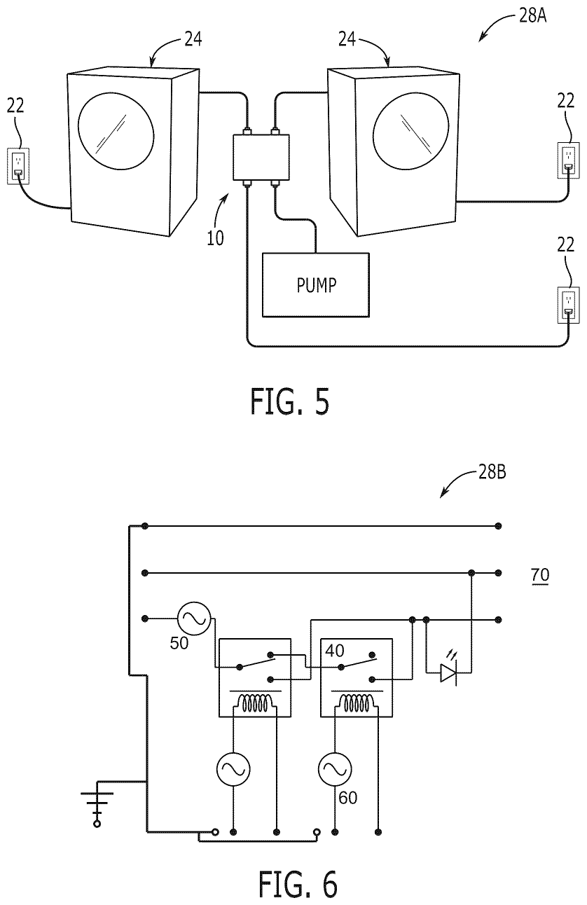

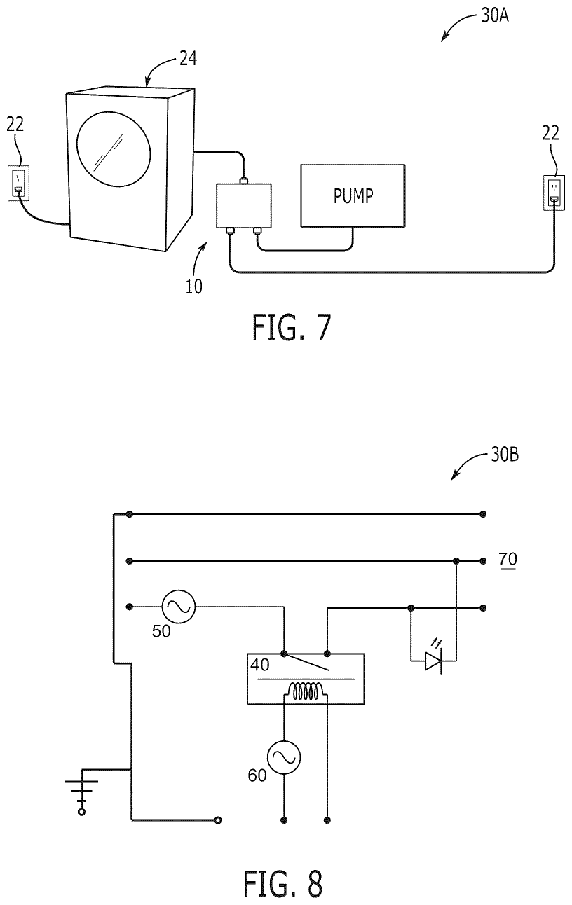

Referring to FIGS. 1 through 8, the subject disclosure may include a mechanical power distribution box 10 for freeze dryer systems 26A, 28A, 30A, etc. The term “mechanical” confers that no MOSFET semi-conductors nor complex electronics are utilized, but rather a simple ‘magnetic reed switch’ or ‘mechanical switch’. The mechanical power distribution box 10 may have a housing 12 provides a first panel 14A and a second panel 14B. One of the panels 14A and 14B may provide a (vacuum) pump indicator 15 (such as an LED) to indicate power is flowing to a pump. One of the panels 14A and 14B may provide a breaker indicator 18 (such as an LED) to indicate an automatic power shut off when too much current passes through a circuit, thereby preventing overheating and the risk of fire.

Through one or both panels 14A and 14B the mechanical power distribution box 10 may provide a box power receptacle 16A and a single pump power receptacle 16B. The box power receptacle 16A is configured to be electrically coupled to an external power circuit 22, such as a wall circuit. The pump power receptacle 16B is configured to electrically couple to and power the sole vacuum pump of one or more freeze dryer systems 26A, 28A, 30A.

Also provided by the mechanical power distribution box 10 are one or more pump port inlets 20, preferably on one of the panels 14A or 14B that the box power and single pump power receptacles 16A and 16B are not located. Each pump port inlet 20 is configured to provide electrical power to a respective freeze dryer 24 by way of the box power receptacle 16A.

Referring to FIGS. 4, 6, and 8, wiring diagrams are provided to illustrate relays 40, amp breakers 50 and amp fuses 60 as well as the ground, live, and neutral nodes 70 in the power circuitry. The relays 40 are configured to interrupt power to the single pump power receptacle 16B and thus the vacuum pump. The one or more pump port inlets 20 couple to external trigger (the respective one or more freeze dryers 24 to activate the relay 40 to selectively power the sole vacuum pump.

The relay distribution box 10 performs very well at 100% isolating the amperage from the freeze dryer(s) and the sole vacuum pump by way of, in some embodiments, a 15-amp power relay 40 per each freeze dryer 24, next sends the output to a (in some embodiments NEMA) rated box power receptacle 16A to allow MAINS power to pass to the final output (single pump power receptacle 16B). The relay distribution box 10 may use one or more (in some embodiments, IEC) pump port inlets/receptacles 20 to allow the user to selectively trigger the relay on and off. All items may be installed in an enclosure or housing 12 including safety features like a 15-amp breaker 50 and fused trigger inputs amp fuses 60, wherein the subject disclosure enables multiple freeze dryers 24 to selectively and operatively associate with a single vacuum pump.

A method of installing and using the subject disclosure may include the following for improving a convention of arrangement of multiple freeze dryers, each with their own dedicated vacuum pump: unplug the vacuum pump from each the freeze dryers 24, plug only one vacuum pump (of the previously used plurality of vacuum pumps) into the pump power receptacle 16b of the power distribution box 10. Then plug each freeze dryer into one of the one or more pump port inlets 20, respectively, of the power distribution box 10. Finally, plug the power distribution box 10, by way of the box power receptacle 16a, into a dedicated external power circuit 22.

Additionally, the subject disclosure could be used to isolate or strengthen other loads (lighting, motors, etc.) from other control systems, manually or via a computer.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A mechanical power distribution system enabling a plurality of freeze dryers by way of a single vacuum pump, the system comprising:
an enclosure providing a box power receptacle, a single pump power receptacle, and a plurality of pump port inlets; and
a relay electrically coupled between the single pump power receptacle and the plurality of pump port inlets, wherein the relay is configured to selectively interrupt power to the plurality of pump port inlets.

2. The system of claim 1, wherein the single vacuum pump is electrically coupled to the single pump power receptacle, and wherein the plurality of freeze dryers is electrically coupled to the plurality of pump port inlets, respectively.

3. The system of claim 2, wherein the box power receptacle and the single pump power receptacle are disposed on a first panel of the enclosure, and wherein the plurality of pump port inlets is disposed on a second panel of the enclosure.

4. A method of installing a plurality of freeze dryers by way of a single vacuum pump, the method comprising:
providing the mechanical power distribution system of claim 1;
electrically coupling the single vacuum pump to the single pump power receptacle; and
electrically coupling the plurality of freeze dryers to the plurality of pump port inlets, respectively.
